(19) United States
(12) Patent Application Publication
(10) Pub. No.: US 2022/0372401 A1
(43) Pub. Date: Nov. 24, 2022

(54) LIQUID HAND DISHWASHING DETERGENT COMPOSITION

(71) Applicant: The Procter & Gamble Company, Cincinnati, OH (US)

(72) Inventors: Pieter Jan Maria SAVEYN, Destelbergen (BE); Evelyne Johanna Lutgarde VAN HECKE, Leerne (BE)

(21) Appl. No.: 17/737,288

(22) Filed: May 5, 2022

(30) Foreign Application Priority Data
May 10, 2021 (EP) 21172952.0
Nov. 23, 2021 (EP) 21209767.9

(51) Int. Cl. C11D 1/94; C11D 11/00; C11D 3/00; C11D 3/22

(52) U.S. Cl. CPC C11D 1/94; C11D 11/0023; C11D 3/0094; C11D 3/222; C11D 1/29

(57) ABSTRACT

The need for a liquid detergent composition, especially a hand dishwashing liquid detergent which provides improved sudsing, especially when used in hard water conditions and in the presence of greasy soils, and providing a desirably viscosity, while not aggravating skin dryness, can be provided by formulating the liquid detergent composition using a hydroxypropylcellulose polymer having a defined molecular weight.

### FIELD OF THE INVENTION

The invention relates to liquid hand dishwashing detergent compositions, which provide improved sudsing, improved finished product viscosity control and easier processibility, while not aggravating skin dryness.

### BACKGROUND OF THE INVENTION

During manual dishwashing, the user typically relies on the level of suds to indicate the remaining cleaning efficacy of the diluted detergent composition. A high suds volume and/or stable, long-lasting suds longevity (i.e., mileage) indicates to the user that sufficient active ingredients (e.g., surfactants) remain, in order to perform the desired cleaning. Poor suds longevity typically leads to the user dosing additional detergent composition even when cleaning efficacy remains.

Anionic surfactants have been used, typically in combination with cosurfactants, especially amphoteric and zwitterionic co-surfactants such as amine oxide and betaines, to provide suds during dishwashing, with alkyl sulphate and alkyl alkoxy sulphates being found to be particularly effective at providing improved sudsing in addition to the desired cleaning. However, such anionic surfactants have been found to leave hands feeling dry after dishwashing.

The suds volume and longevity are significantly affected by the level of the hardness of the water used, and by the presence of greasy soils. As such, the satisfaction of the user can often depend not on the efficacy of the detergent composition itself, but on the hardness of the water used and the presence of greasy soils in the wash liquor.

Polymers, such as hydroxypropyl methylcellulose have been used to improve sudsing. However, detergent compositions comprising hydroxypropyl methylcellulose and such polymers have been found to aggravate skin dryness after dishwashing. Moreover, aqueous premixes comprising hydroxypropyl methylcellulose typically have a high viscosity and hence are difficult to formulate into detergent compositions. Moreover, hydroxypropyl methylcellulose increases the viscosity of detergent compositions, often by an undesirable amount.

Hence, there remains a need for a liquid detergent composition, especially a hand dishwashing liquid detergent which provides improved sudsing, especially when used in hard water conditions and in the presence of greasy soils, while not aggravating skin dryness. In addition, there remains a need to provide such a detergent composition having the desired finished product viscosity profile and being easy to formulate and process at a manufacturing location.

WO2010088158A1 relates to hand dishwashing detergent composition comprising a specific anionic surfactant system, a pearlescent agent and a rheology modifier, to provide superior grease cleaning combined with hand mildness. WO2010088159A1 relates to a hand dishwashing detergent composition comprising a humectant, and a pearlescent agent to provide superior grease cleaning and hand mildness. WO2010088161A1 relates to a hand dishwashing detergent composition comprising a protease and a pearlescent agent to provide superior grease cleaning and hand mildness. WO2010088162A1 relates to a hand dishwashing detergent composition comprising a cationic polymer and a pearlescent agent to provide superior grease cleaning and hand mildness. WO2010088163A1 relates to a liquid hand dishwashing detergent composition comprising a cationic polymer and a protease, a method of cleaning dishes with a liquid hand dishwashing detergent composition comprising a cationic polymer and a protease, and a method of providing skin hydration and/or moisturization the context of a manual dishwashing operation, using a liquid hand dishwashing detergent composition comprising a cationic polymer and a protease. WO2010088164A1 relates to a liquid hand dishwashing detergent composition comprising a protease and a humectant, a method of cleaning dishes with a liquid hand dishwashing detergent composition comprising a protease and a humectant, and a method of providing skin hydration and/or moisturization in the context of a manual dishwashing operation, using liquid hand dishwashing detergent composition comprising a protease and a humectant. WO2010088165A1 relates to a liquid hand dishwashing detergent composition comprising a cationic polymer and a humectant, a method of cleaning dishes with a liquid hand dishwashing detergent composition comprising a cationic polymer and a humectant, and a method of providing skin hydration and/or moisturization the context of a manual dishwashing operation, using liquid hand dishwashing detergent composition comprising a cationic polymer and a humectant. WO2012116471A1 relates to a method of manually cleaning dishware using a liquid hand dishwashing detergent composition comprising an anionic surfactant and a cationic polymer, and a method of preventing skin damage and improving the overall look and feel of the skin, in the context of a manual dishwashing operation. WO2012016104A2 relates to a method of cleaning dishware with a liquid detergent composition having a hydrophobic emollient and a crystalline structurant to provide improved hand skin care benefits and superior grease cleaning and/or suds mileage. WO2012015852A1 relates to a dishwashing composition comprising a hydrophobic emollient and an enzyme, preferably a protease, to provide improved hand skin care benefits and superior cleaning and/or suds mileage.

EP0124367A relates to certain polymers, notably hydroxyethyl and hydroxypropyl cellulose, hydroxypropyl guars, xanthan gums, and certain acrylic polymers, which enhance the foam stability of liquid detergents based on dialkyl sulphosuccinates while simultaneously providing increased viscosity. WO2009093150A relates to a light duty liquid detergent composition comprising a low molecular weight hydrophobically modified cellulosic polymer, to provide improved foaming properties. WO2006072385A relates to a fat-dissolving cleaner for hard surfaces, which has great foaming power and comprises an amine oxide surfactant, monoethanolamine and/or triethanolamine, a water-soluble organic solvent, water, and a cellulose-based polymer for increasing the adhesive stability of the foam, said cleaner can be used in a spray bottle for cleaning hard surfaces and especially for removing burned or old grease stains in a method that encompasses the following steps: the cleaner is sprayed on, is let to react, and is wiped off with a moist cleaning cloth, sponge, or other common cleaning device once the foam has collapsed. WO1991013138A relates to the use of low-viscosity grades of surface active, nonionic cellulose ethers possessing inverse water solubility (with respect to temperature) as lather enhancers for lather-producing products, such cellulose ethers include methylcellulose, methylethylcellulose, hydroxypropyl methylcellulose, hydroxypropyl cellulose, and hydroxyethyl methylcellulose, the specific functional contribution of the cellulose ethers is that of imparting a lubricious, dense, stable, and voluminous foam during use of the product.

GB2427614A relates to a light duty dishwashing composition which comprises: an anionic surfactant constituent comprising at least an alkyl ether sulphate or salt thereof and an alkyl sulphate or salt thereof; a polysaccharide based surfactant, preferably a polyglycoside; water; the final composition having a pH from 5-7.5 and the total non-aqueous and non-organic solvent constituents comprise at least 40 weight % of the composition. GB2427614A further discloses that the compositions contained therein can comprise a thickener which can be Natrosol (a hydroxyethylcellulose polymer), amongst other thickeners. GB2427614A does not disclose that hydroxypropylcellulose or any other cellulose-based thickeners disclosed therein, can provide a sudsing benefit, especially when used in hard water conditions and in the presence of greasy soils, while not aggravating skin dryness.

### SUMMARY OF THE INVENTION

The present invention relates to a liquid hand dishwashing detergent composition comprising a surfactant system, wherein the surfactant system comprises: anionic surfactant selected from the group consisting of: alkyl sulphate surfactant, alkyl sulphonate surfactant, alkyl sulphosuccinate and dialkyl sulphosuccinate ester surfactant, and mixtures thereof; and co-surfactant selected from the group consisting of: amphoteric co-surfactant, zwitterionic co-surfactant, and mixtures thereof; characterised in that the liquid hand dishwashing detergent composition further comprises from 0.01% to 3.0% by weight of the composition of a hydroxypropylcellulose polymer wherein the hydroxypropylcellulose polymer has a number average molecular weight of from 5 kDa to 250 kDa.

### DETAILED DESCRIPTION OF THE INVENTION

Formulating the liquid cleaning composition with a surfactant system and a hydroxypropylcellulose polymer, as described herein, has been found to result in improved sudsing, especially when used in hard water conditions and in the presence of greasy soils, while not aggravating skin dryness, while having a more desired finished product viscosity profile and being easy to formulate.

As used herein, articles such as “a” and “an” when used in a claim, are understood to mean one or more of what is claimed or described.

The term “comprising” as used herein means that steps and ingredients other than those specifically mentioned can be added. This term encompasses the terms “consisting of” and “consisting essentially of.” The compositions of the present invention can comprise, consist of, and consist essentially of the essential elements and limitations of the invention described herein, as well as any of the additional or optional ingredients, components, steps, or limitations described herein.

The term “dishware” as used herein includes cookware and tableware made from, by non-limiting examples, ceramic, china, metal, glass, plastic (e.g., polyethylene, polypropylene, polystyrene, etc.) and wood.

The term “grease” or “greasy” as used herein means materials comprising at least in part (i.e., at least 0.5 wt % by weight of the grease in the material) saturated and unsaturated fats and oils, preferably oils and fats derived from animal sources such as beef, pig and/or chicken.

The terms “include”, “includes” and “including” are meant to be non-limiting.

The term “particulate soils” as used herein means inorganic and especially organic, solid soil particles, especially food particles, such as for non-limiting examples: finely divided elemental carbon, baked grease particle, and meat particles.

The term “sudsing profile” as used herein refers to the properties of a cleaning composition relating to suds character during the dishwashing process. The term “sudsing profile” of a cleaning composition includes initial suds volume generated upon dissolving and agitation, typically manual agitation, of the cleaning composition in the aqueous washing solution, and the retention of the suds during the dishwashing process. Preferably, hand dishwashing cleaning compositions characterized as having “good sudsing profile” tend to have high initial suds volume and/or sustained suds volume, particularly during a substantial portion of or for the entire manual dishwashing process. This is important as the consumer uses high suds as an indicator that enough cleaning composition has been dosed. Moreover, the consumer also uses the sustained suds volume as an indicator that enough active cleaning ingredients (e.g., surfactants) are present, even towards the end of the dishwashing process. The consumer usually renews the washing solution when the sudsing subsides. Thus, a low sudsing cleaning composition will tend to be replaced by the consumer more frequently than is necessary because of the low sudsing level.

It is understood that the test methods that are disclosed in the Test Methods Section of the present application must be used to determine the respective values of the parameters of Applicants' inventions as described and claimed herein.

All percentages are by weight of the total composition, as evident by the context, unless specifically stated otherwise. All ratios are weight ratios, unless specifically stated otherwise, and all measurements are made at 25° C., unless otherwise designated.

### Liquid Cleaning Composition

The cleaning composition is a liquid cleaning composition, preferably a liquid hand dishwashing cleaning composition, and hence is in liquid form. The liquid cleaning composition is preferably an aqueous cleaning composition. As such, the composition can comprise from 50% to 85%, preferably from 50% to 75%, by weight of the total composition of water.

The liquid cleaning composition has a pH greater than 6.0, or a pH of from 6.0 to 12.0, preferably from 7.0 to 11.0, more preferably from 8.0 to 10.0, measured as a 10% aqueous solution in demineralized water at 20 degrees ° C.

The liquid cleaning composition of the present invention can be Newtonian or non-Newtonian, preferably Newtonian. Preferably, the composition has a viscosity of from 10 mPa·s to 10,000 mPa·s, preferably from 100 mPa·s to 5,000 mPa·s, more preferably from 300 mPa·s to 2,000 mPa·s, or most preferably from 500 mPa·s to 1,500 mPa·s, alternatively combinations thereof.

### Surfactant System

The liquid cleaning composition comprises from 5.0% to 50%, preferably from 6.0% to 40%, most preferably from 15% to 35%, by weight of the total composition of a surfactant system.

### Anionic Surfactant

The surfactant system comprises an anionic surfactant. The surfactant system can comprise at least 50%, preferably from 60% to 90%, more preferably from 65% to 85% by weight of the surfactant system of the anionic surfactant. The surfactant system is preferably free of fatty acid or salt thereof, since such fatty acids impede the generation of suds.

Suitable anionic surfactants can be selected from the group consisting of: alkyl sulphate surfactant, alkyl sulphonate surfactant, alkyl sulphosuccinate and dialkyl sulphosuccinate ester surfactants, and mixtures thereof.

The anionic surfactant can comprise at least 70%, preferably at least 85%, more preferably 100% by weight of the anionic surfactant of alkyl sulphate anionic surfactant.

The mol average alkyl chain length of the alkyl sulphate anionic surfactant can be from 8 to 18, preferably from 10 to 14, more preferably from 12 to 14, most preferably from 12 to 13 carbon atoms, in order to provide a combination of improved grease removal and enhanced speed of cleaning.

The alkyl chain of the alkyl sulphate anionic surfactant can have a mol fraction of C12 and C13 chains of at least 50%, preferably at least 65%, more preferably at least 80%, most preferably at least 90%. Suds mileage is particularly improved, especially in the presence of greasy soils, when the C13/C12 mol ratio of the alkyl chain is at least 57/43, preferably from 60/40 to 90/10, more preferably from 60/40 to 80/20, most preferably from 60/40 to 70/30, while not compromising suds mileage in the presence of particulate soils.

The relative molar amounts of C13 and C12 alkyl chains in the alkyl sulphate anionic surfactant can be derived from the carbon chain length distribution of the anionic surfactant. The carbon chain length distribution of the alkyl chains of the alkyl sulphate anionic surfactants can be obtained from the technical data sheets from the suppliers for the surfactant or constituent alkyl alcohol. Alternatively, the chain length distribution and average molecular weight of the fatty alcohols, used to make the alkyl sulphate anionic surfactant, can also be determined by methods known in the art. Such methods include capillary gas chromatography with flame ionisation detection on medium polar capillary column, using hexane as the solvent. The chain length distribution is based on the starting alcohol and alkoxylated alcohol. As such, the alkyl sulphate anionic surfactant should be hydrolysed back to the corresponding alkyl alcohol and alkyl alkoxylated alcohol before analysis, for instance using hydrochloric acid.

The alkyl sulphate surfactant can be alkoxylated or free of alkoxylation. When alkoxylated, the alkyl sulphate anionic surfactant can have an average degree of alkoxylation of less than 3.5, preferably from 0.3 to 2.0, more preferably from 0.5 to 0.9, in order to improve low temperature physical stability and improve suds mileage of the compositions of the present invention. When alkoxylated, ethoxylation is preferred.

The average degree of alkoxylation is the mol average degree of alkoxylation (i.e., mol average alkoxylation degree) of all the alkyl sulphate anionic surfactant. Hence, when calculating the mol average alkoxylation degree, the mols of non-alkoxylated sulphate anionic surfactant are included:

Mol average alkoxylation degree=(x1*alkoxylation degree of surfactant 1+x2*alkoxylation degree of surfactant 2+ . . . )/(x1+x2+ . . . )

wherein x1, x2, . . . are the number of moles of each alkyl (or alkoxy) sulphate anionic surfactant of the mixture and alkoxylation degree is the number of alkoxy groups in each alkyl sulphate anionic surfactant.

Preferred alkyl alkoxy sulphates are alkyl ethoxy sulphates

The alkyl sulphate anionic surfactant can have a weight average degree of branching of at least 10%, preferably from 20% to 60%, more preferably from 30% to 50%.

The alkyl sulphate anionic surfactant can comprise at least 5%, preferably at least 10%, most preferably at least 25%, by weight of the alkyl sulphate anionic surfactant, of branching on the C2 position (as measured counting carbon atoms from the sulphate group for non-alkoxylated alkyl sulphate anionic surfactants, and the counting from the alkoxy-group furthest from the sulphate group for alkoxylated alkyl sulphate anionic surfactants). More preferably, greater than 75%, even more preferably greater than 90%, by weight of the total branched alkyl content consists of C1-C5 alkyl moiety, preferably C1-C2 alkyl moiety. It has been found that formulating the inventive compositions using alkyl sulphate surfactants having the aforementioned degree of branching results in improved low temperature stability. Such compositions require less solvent in order to achieve good physical stability at low temperatures. As such, the compositions can comprise lower levels of organic solvent, of less than 5.0% by weight of the liquid cleaning composition of organic solvent, while still having improved low temperature stability. Higher surfactant branching also provides faster initial suds generation, but typically less suds mileage. The weight average branching, described herein, has been found to provide improved low temperature stability, initial foam generation and suds longevity.

The weight average degree of branching for an anionic surfactant mixture can be calculated using the following formula:

Weight average degree of branching (%)=[(x1*wt % branched alcohol 1 in alcohol 1+x2*wt % branched alcohol 2 in alcohol 2+ . . . )/(x1+x2+ . . . )]*100

wherein x1, x2, . . . are the weight in grams of each alcohol in the total alcohol mixture of the alcohols which were used as starting material before (alkoxylation and) sulphation to produce the alkyl (alkoxy) sulphate anionic surfactant. In the weight average degree of branching calculation, the weight of the alkyl alcohol used to form the alkyl sulphate anionic surfactant which is not branched is included.

The weight average degree of branching and the distribution of branching can typically be obtained from the technical data sheet for the surfactant or constituent alkyl alcohol. Alternatively, the branching can also be determined through analytical methods known in the art, including capillary gas chromatography with flame ionisation detection on medium polar capillary column, using hexane as the solvent. The weight average degree of branching and the distribution of branching is based on the starting alcohol used to produce the alkyl sulphate anionic surfactant.

Suitable counterions include alkali metal cation earth alkali metal cation, alkanolammonium or ammonium or substituted ammonium, but preferably sodium.

Suitable examples of commercially available alkyl sulphate anionic surfactants include, those derived from alcohols sold under the Neodol® brand-name by Shell, or the Lial®, Isalchem®, and Safol® brand-names by Sasol, or some of the natural alcohols produced by The Procter & Gamble Chemicals company. The alcohols can be blended in order to achieve the desired mol fraction of C12 and C13 chains and the desired C13/C12 ratio, based on the relative fractions of C13 and C12 within the starting alcohols, as obtained from the technical data sheets from the suppliers or from analysis using methods known in the art.

The performance can be affected by the width of the alkoxylation distribution of the alkoxylated alkyl sulphate anionic surfactant, including grease cleaning, sudsing, low temperature stability and viscosity of the finished product. The alkoxylation distribution, including its broadness can be varied through the selection of catalyst and process conditions when making the alkoxylated alkyl sulphate anionic surfactant.

If ethoxylated alkyl sulphate is present, without wishing to be bound by theory, through tight control of processing conditions and feedstock material compositions, both during alkoxylation especially ethoxylation and sulphation steps, the amount of 1,4-dioxane by-product within alkoxylated especially ethoxylated alkyl sulphates can be reduced. Based on recent advances in technology, a further reduction of 1,4-dioxane by-product can be achieved by subsequent stripping, distillation, evaporation, centrifugation, microwave irradiation, molecular sieving or catalytic or enzymatic degradation steps. Processes to control 1,4-dioxane content within alkoxylated/ethoxylated alkyl sulphates have been described extensively in the art. Alternatively 1,4-dioxane level control within detergent formulations has also been described in the art through addition of 1,4-dioxane inhibitors to 1,4-dioxane comprising formulations, such as 5,6-dihydro-3-(4-morpholinyl)-1-[4-(2-oxo-1-piperidinyl)-phenyl]-2-(1-H)-pyridone, 3-α-hydroxy-7-oxo stereoisomer-mixtures of cholinic acid, 3-(N-methyl amino)-L-alanine, and mixtures thereof.

Anionic alkyl sulphonate or sulphonic acid surfactants suitable for use herein include the acid and salt forms of alkylbenzene sulphonates, alkyl ester sulphonates, primary and secondary alkane sulphonates such as paraffin sulfonates, alfa or internal olefin sulphonates, alkyl sulphonated (poly)carboxylic acids, and mixtures thereof. Suitable anionic sulphonate or sulphonic acid surfactants include: C5-C20 alkylbenzene sulphonates, more preferably C10-C16 alkylbenzene sulphonates, more preferably C11-C13 alkylbenzene sulphonates, C5-C20 alkyl ester sulphonates especially C5-C20 methyl ester sulfonates, C6-C22 primary or secondary alkane sulphonates, C5-C20 sulphonated (poly)carboxylic acids, and any mixtures thereof, but preferably C11-C13 alkylbenzene sulphonates. The aforementioned surfactants can vary widely in their 2-phenyl isomer content. Compared with sulfonation of alpha olefins, the sulfonation of internal olefins can occur at any position since the double bond is randomly positioned, which leads to the position of hydrophilic sulfonate and hydroxyl groups of IOS in the middle of the alkyl chain, resulting in a variety of twin-tailed branching structures. Alkane sulphonates include paraffin sulphonates and other secondary alkane sulfonate (such as Hostapur SAS60 from Clariant).

Alkyl sulfosuccinate and dialkyl sulfosuccinate esters are organic compounds with the formula MO3SCH(CO2R′)CH2CO2R where R and R can be H or alkyl groups, and M is a counter-ion such as sodium (Na). Alkyl sulfosuccinate and dialkyl sulfosuccinate ester surfactants can be alkoxylated or non-alkoxylated, preferably non-alkoxylated. The surfactant system may comprise further anionic surfactant. However, the composition preferably comprises less than 30%, preferably less than 15%, more preferably less than 10% by weight of the surfactant system of further anionic surfactant. Most preferably, the surfactant system comprises no further anionic surfactant, preferably no other anionic surfactant than alkyl sulphate anionic surfactant.

### Co-Surfactant

In order to improve surfactant packing after dilution and hence improve suds mileage, the surfactant system can comprise a co-surfactant. The co-surfactant can be selected from the group consisting of an amphoteric surfactant, a zwitterionic surfactant and mixtures thereof.

The anionic surfactant to the co-surfactant weight ratio can be from 1:1 to 8:1, preferably from 2:1 to 5:1, more preferably from 2.5:1 to 4:1.

The composition preferably comprises from 0.1% to 20%, more preferably from 0.5% to 15% and especially from 2% to 10% by weight of the cleaning composition of the co-surfactant.

The surfactant system of the cleaning composition of the present invention preferably comprises up to 50%, preferably from 10% to 40%, more preferably from 15% to 35%, by weight of the surfactant system of a co-surfactant.

The co-surfactant is preferably an amphoteric surfactant, more preferably an amine oxide surfactant.

The amine oxide surfactant can be linear or branched, though linear are preferred. Suitable linear amine oxides are typically water-soluble, and characterized by the formula R1-N(R2)(R3) O wherein R1 is a C8-18 alkyl, and the R2 and R3 moieties are selected from the group consisting of C1-3 alkyl groups, C1-3 hydroxyalkyl groups, and mixtures thereof. For instance, R2 and R3 can be selected from the group consisting of: methyl, ethyl, propyl, isopropyl, 2-hydroxethyl, 2-hydroxypropyl and 3-hydroxypropyl, and mixtures thereof, though methyl is preferred for one or both of R2 and R3. The linear amine oxide surfactants in particular may include linear C10-C18 alkyl dimethyl amine oxides and linear C8-C12 alkoxy ethyl dihydroxy ethyl amine oxides.

Preferably, the amine oxide surfactant is selected from the group consisting of: alkyl dimethyl amine oxide, alkyl amido propyl dimethyl amine oxide, and mixtures thereof. Alkyl dimethyl amine oxides are particularly preferred, such as C8-18 alkyl dimethyl amine oxides, or C10-16 alkyl dimethyl amine oxides (such as coco dimethyl amine oxide). Suitable alkyl dimethyl amine oxides include C10 alkyl dimethyl amine oxide surfactant, C10-12 alkyl dimethyl amine oxide surfactant, C12-C14 alkyl dimethyl amine oxide surfactant, and mixtures thereof. C12-C14 alkyl dimethyl amine oxide are particularly preferred.

Alternative suitable amine oxide surfactants include mid-branched amine oxide surfactants. As used herein, “mid-branched” means that the amine oxide has one alkyl moiety having n1 carbon atoms with one alkyl branch on the alkyl moiety having n2 carbon atoms. The alkyl branch is located on the a carbon from the nitrogen on the alkyl moiety. This type of branching for the amine oxide is also known in the art as an internal amine oxide. The total sum of n1 and n2 can be from 10 to 24 carbon atoms, preferably from 12 to 20, and more preferably from 10 to 16. The number of carbon atoms for the one alkyl moiety (n1) is preferably the same or similar to the number of carbon atoms as the one alkyl branch (n2) such that the one alkyl moiety and the one alkyl branch are symmetric. As used herein “symmetric” means that |n1−n2| is less than or equal to 5, preferably 4, most preferably from 0 to 4 carbon atoms in at least 50 wt %, more preferably at least 75 wt % to 100 wt % of the mid-branched amine oxides for use herein. The amine oxide further comprises two moieties, independently selected from a C1-3 alkyl, a C1-3 hydroxyalkyl group, or a polyethylene oxide group containing an average of from about 1 to about 3 ethylene oxide groups. Preferably, the two moieties are selected from a C1-3 alkyl, more preferably both are selected as Cl alkyl.

Alternatively, the amine oxide surfactant can be a mixture of amine oxides comprising a mixture of low-cut amine oxide and mid-cut amine oxide. The amine oxide of the composition of the invention can then comprises:
a) from about 10% to about 45% by weight of the amine oxide of low-cut amine oxide of formula R1R2R3AO wherein R1 and R2 are independently selected from hydrogen, C1-C4 alkyls or mixtures thereof, and R3 is selected from C10 alkyls and mixtures thereof; and
b) from 55% to 90% by weight of the amine oxide of mid-cut amine oxide of formula R4R5R6AO wherein R4 and R5 are independently selected from hydrogen, C1-C4 alkyls or mixtures thereof, and R6 is selected from C12-C16 alkyls or mixtures thereof

In a preferred low-cut amine oxide for use herein R3 is n-decyl, with preferably both R1 and R2 being methyl. In the mid-cut amine oxide of formula R4R5R6AO, R4 and R5 are preferably both methyl.

Preferably, the amine oxide comprises less than about 5%, more preferably less than 3%, by weight of the amine oxide of an amine oxide of formula R7R8R9AO wherein R7 and R8 are selected from hydrogen, C1-C4 alkyls and mixtures thereof and wherein R9 is selected from C8 alkyls and mixtures thereof. Limiting the amount of amine oxides of formula R7R8R9AO improves both physical stability and suds mileage.

Suitable zwitterionic surfactants include betaine surfactants. Such betaine surfactants includes alkyl betaines, alkylamidobetaine, amidazoliniumbetaine, sulphobetaine (INCI Sultaines) as well as the phosphobetaine, and preferably meets formula (I):

R¹—[CO—X(CH₂)ₙ]ₓ—N⁺(R²)(R₃)—(CH₂)ₘ—[CH(OH)—CH₂]_{y}—Y⁻

Wherein in formula (I),

R1 is selected from the group consisting of: a saturated or unsaturated C6-22 alkyl residue, preferably C8-18 alkyl residue, more preferably a saturated C10-16 alkyl residue, most preferably a saturated C12-14 alkyl residue;

X is selected from the group consisting of: NH, NR4 wherein R4 is a C1-4 alkyl residue, O, and S,

n is an integer from 1 to 10, preferably 2 to 5, more preferably 3,

x is 0 or 1, preferably 1,

R2 and R3 are independently selected from the group consisting of: a C1-4 alkyl residue, hydroxy substituted such as a hydroxyethyl, and mixtures thereof, preferably both R2 and R3 are methyl,

m is an integer from 1 to 4, preferably 1, 2 or 3,

y is 0 or 1, and

Y is selected from the group consisting of: COO, SO3, OPO(OR5)O or P(O)(OR5)O, wherein R5 is H or a C1-4 alkyl residue.

Preferred betaines are the alkyl betaines of formula (Ia), the alkyl amido propyl betaine of formula (Ib), the sulphobetaine of formula (Ic) and the amido sulphobetaine of formula (Id):

R¹—N⁺(CH₃)₂—CH₂COO⁻ (IIa)

R¹—CO—NH—(CH₂)₃—N⁺(CH₃)₂—CH₂COO⁻ (IIb)

R¹—N⁺(CH₃)₂—CH₂CH(OH)CH₂SO₃⁻ (IIc)

R¹—CO—NH—(CH₂)₃—N⁺(CH₃)₂—CH₂CH(OH)CH₂SO₃⁻ (IId)

in which R1 has the same meaning as in formula (I). Particularly preferred are the carbobetaines [i.e. wherein Y—═COO— in formula (I)] of formulae (Ia) and (Ib), more preferred are the alkylamidobetaine of formula (Ib).

Suitable betaines can be selected from the group consisting or [designated in accordance with INCI]: capryl/capramidopropyl betaine, cetyl betaine, cetyl amidopropyl betaine, cocamidoethyl betaine, cocamidopropyl betaine, cocobetaines, decyl betaine, decyl amidopropyl betaine, hydrogenated tallow betaine/amidopropyl betaine, isostearamidopropyl betaine, lauramidopropyl betaine, lauryl betaine, myristyl amidopropyl betaine, myristyl betaine, oleamidopropyl betaine, oleyl betaine, palmamidopropyl betaine, palmitamidopropyl betaine, palm-kernelamidopropyl betaine, stearamidopropyl betaine, stearyl betaine, tallowamidopropyl betaine, tallow betaine, undecylenamidopropyl betaine, undecyl betaine, and mixtures thereof. Preferred betaines are selected from the group consisting of: cocamidopropyl betaine, cocobetaines, lauramidopropyl betaine, lauryl betaine, myristyl amidopropyl betaine, myristyl betaine, and mixtures thereof. Cocamidopropyl betaine is particularly preferred.

### Nonionic Surfactant:

The surfactant system can further comprise a nonionic surfactant. Suitable nonionic surfactants include alkoxylated alcohol nonionic surfactants, alkyl polyglucoside nonionic surfactants, and mixtures thereof.

### Alkoxylated Alcohol Nonionic Surfactant:

Preferably, the surfactant system of the composition of the present invention further comprises from 1% to 25%, preferably from 1.25% to 20%, more preferably from 1.5% to 15%, most preferably from 1.5% to 5%, by weight of the surfactant system, of an alkoxylated alcohol non-ionic surfactant.

Preferably, the alkoxylated alcohol non-ionic surfactant is a linear or branched, primary or secondary alkyl alkoxylated non-ionic surfactant, preferably an alkyl ethoxylated non-ionic surfactant, preferably comprising on average from 9 to 15, preferably from 10 to 14 carbon atoms in its alkyl chain and on average from 5 to 12, preferably from 6 to 10, most preferably from 7 to 8, units of ethylene oxide per mole of alcohol.

### Alkyl Polyglucoside Nonionic Surfactant:

If present, the alkyl polyglucoside can be present in the surfactant system at a level of from 0.5% to 20%, preferably from 0.75% to 15%, more preferably from 1% to 10%, most preferably from 1% to 5% by weight of the surfactant composition. Alkyl polyglucoside nonionic surfactants are typically more sudsing than other nonionic surfactants such as alkyl ethoxlated alcohols.

A combination of alkylpolyglucoside and anionic surfactant especially alkyl sulfate anionic surfactant, has been found to improve polymerized grease removal, suds mileage performance, reduced viscosity variation with changes in the surfactant and/or system, and a more sustained Newtonian rheology.

The alkyl polyglucoside surfactant can be selected from C6-C18 alkyl polyglucoside surfactant. The alkyl polyglucoside surfactant can have a number average degree of polymerization of from 0.1 to 3.0, preferably from 1.0 to 2.0, more preferably from 1.2 to 1.6. The alkyl polyglucoside surfactant can comprise a blend of short chain alkyl polyglucoside surfactant having an alkyl chain comprising 10 carbon atoms or less, and mid to long chain alkyl polyglucoside surfactant having an alkyl chain comprising greater than 10 carbon atoms to 18 carbon atoms, preferably from 12 to 14 carbon atoms.

Short chain alkyl polyglucoside surfactants have a monomodal chain length distribution between C8-C10, mid to long chain alkyl polyglucoside surfactants have a monomodal chain length distribution between C10-C18, while mid chain alkyl polyglucoside surfactants have a monomodal chain length distribution between C12-C14. In contrast, C8 to C18 alkyl polyglucoside surfactants typically have a monomodal distribution of alkyl chains between C8 and C18, as with C8 to C16 and the like. As such, a combination of short chain alkyl polyglucoside surfactants with mid to long chain or mid chain alkyl polyglucoside surfactants have a broader distribution of chain lengths, or even a bimodal distribution, than non-blended C8 to C18 alkyl polyglucoside surfactants. Preferably, the weight ratio of short chain alkyl polyglucoside surfactant to long chain alkyl polyglucoside surfactant is from 1:1 to 10:1, preferably from 1.5:1 to 5:1, more preferably from 2:1 to 4:1. It has been found that a blend of such short chain alkyl polyglucoside surfactant and long chain alkyl polyglucoside surfactant results in faster dissolution of the detergent solution in water and improved initial sudsing, in combination with improved suds stability.

C8-C16 alkyl polyglucosides are commercially available from several suppliers (e.g., Simusol® surfactants from Seppic Corporation; and Glucopon® 600 CSUP, Glucopon® 650 EC, Glucopon® 600 CSUP/MB, and Glucopon® 650 EC/MB, from BASF Corporation). Glucopon® 215UP is a preferred short chain APG surfactant. Glucopon® 600CSUP is a preferred mid to long chain APG surfactant.

In preferred compositions, the surfactant system can comprise an alkyl sulfate anionic surfactant having an average degree of branching of less than 10% and alkyl polyglucoside nonionic surfactant.

### Hydroxypropyl Cellulose

The liquid hand dishwashing detergent comprises a hydroxypropylcellulose polymer (HPC). Hydroxypropyl cellulose is a derivative of cellulose with both water solubility and organic solubility.

The hydroxypropylcellulose polymer of use in the compositions of the present invention has a number average molecular weight of from 5 kDa to 250 kDa. The hydroxypropylcellulose polymer can have a number average molecular weight of from 10 kDa to 100 kDa, preferably 30 kDa to 50 kDa.

It is believed that this number average molecular weight range results in a good dissolution of the hydroxypropylcellulose polymer in aqueous premixes as well as in the final liquid detergent composition, as well as providing the desired viscosity control of the resultant liquid detergent composition. In addition, hydroxypropylcellulose polymers having the desired molecular weight are believed to effectively position themselves at the water-air interface in order to improve sudsing behaviour.

The composition comprises from 0.01% to 3.0%, preferably from 0.05% to 2.0%, more preferably from 0.1% to 1.0% by weight of the composition of the hydroxypropylcellulose polymer.

The hydroxypropylcellulose polymer is preferably unsubstituted, apart from the hydroxypropyl substitutions. Hydroxypropylcellulose polymers have the structure:

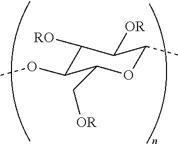

wherein each R is independently H or CH2CH(OR′)CH3, wherein R′ is H or R. In the present compositions, n is preferably from 15 to 650, preferably from 25 to 250, more preferably from 80 to 130. As such, suitable hydroxypropylcellulose is free from any other substitution.

Hydroxypropylcellulose is an ether of cellulose in which some of the hydroxyl groups in the repeating glucose units have been hydroxypropylated forming —OCH2CH(OH)CH3 groups using propylene oxide. The average number of substituted hydroxyl groups per glucose unit is referred to as the degree of substitution (DS). Complete substitution would provide a DS of 3. Because the hydroxypropyl group added contains a hydroxyl group, this can also be etherified during preparation of hydroxypropylcellulose. When this occurs, the number of moles of hydroxypropyl groups per glucose ring, moles of substitution (MS), can be higher than 3. In such cases, at least some of the R is CH2CH(OR′)CH3, wherein R′ is independently H or CH2CH(OR′)CH3, depending on whether further etherification of the hydroxyl group of the hydroxypropyl derivative has occurred. The hydroxypropylcellulose polymer of use in the present compositions preferably has a degree of molar substitution (MS) of hydroxypropyl of from 0.5 to 5.0, more preferably from 1.0 to 4.5, most preferably 2.0 to 4.0.

This degree of molar substitution (MS) is believed to provide good solubility in water and in the liquid detergent composition, as well as providing an improved rheology profile, and a hydrophilic-lipophilic balance which results in reduced skin dryness and hence less aggravation of the skin during and after washing compared to alternative cellulosic polymers such as for example hydroxypropylmethylcellulose (HPMC).

The average degree of molar substitution (MS) can be defined by the number of moles of hydroxypropyl groups substituted on the cellulose during making of the hydroxypropylcellulose polymer. The average degree of molar substitution (MS) can be measured using NMR spectroscopy, as described in “Determination of molar substitution (MS) and degree of substitution (DS) of hydroxypropyl cellulose by nuclear magnetic resonance spectrometry—F. Floyd—Analytical Chemistry, volume 44 Issue 1, January 1972, starting page 178”.

Suitable HPC polymers are commercially available from Ashland under the Klucel® tradename. One particularly suitable HPC polymer is the Klucel® E polymer from Ashland, or Celny® from Nippon Soda Company. Alternatively suitable HPC polymers can equally be bought from Sigma-Aldrich.

### Further Ingredients:

The composition can comprise further ingredients such as those selected from: amphiphilic alkoxylated polyalkyleneimines, cyclic polyamines, triblock copolymers, hydrotropes, organic solvents, other adjunct ingredients such as those described herein, and mixtures thereof.

### Amphiphilic Alkoxylated Polyalkyleneimine:

The composition of the present invention may further comprise from 0.05% to 2%, preferably from 0.07% to 1% by weight of the total composition of an amphiphilic polymer. Suitable amphiphilic polymers can be selected from the group consisting of: amphiphilic alkoxylated polyalkyleneimine and mixtures thereof. The amphiphilic alkoxylated polyalkyleneimine polymer has been found to reduce gel formation on the hard surfaces to be cleaned when the liquid composition is added directly to a cleaning implement (such as a sponge) before cleaning and consequently brought in contact with heavily greased surfaces, especially when the cleaning implement comprises a low amount to nil water such as when light pre-wetted sponges are used.

A preferred amphiphilic alkoxylated polyethyleneimine polymer has the general structure of formula (I):

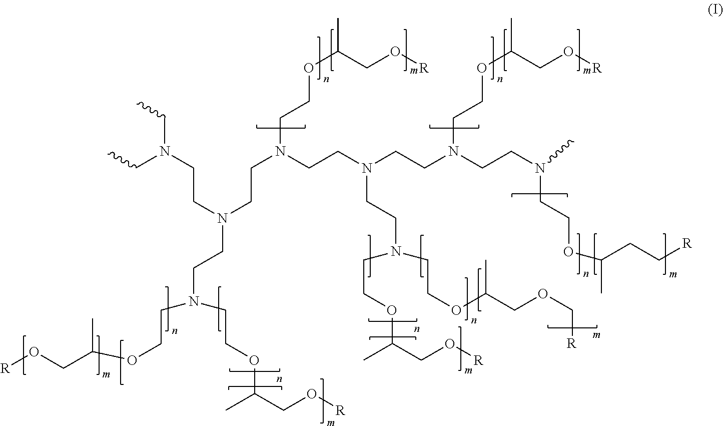

wherein the polyethyleneimine backbone has a weight average molecular weight of 600, n of formula (I) has an average of 10, m of formula (I) has an average of 7 and R of formula (I) is selected from hydrogen, a C1-C4 alkyl and mixtures thereof, preferably hydrogen. The degree of permanent quaternization of formula (I) may be from 0% to 22% of the polyethyleneimine backbone nitrogen atoms. The molecular weight of this amphiphilic alkoxylated polyethyleneimine polymer preferably is between 10,000 and 15,000 Da.

More preferably, the amphiphilic alkoxylated polyethyleneimine polymer has the general structure of formula (I) but wherein the polyethyleneimine backbone has a weight average molecular weight of 600 Da, n of Formula (I) has an average of 24, m of Formula (I) has an average of 16 and R of Formula (I) is selected from hydrogen, a C₁-C₄ alkyl and mixtures thereof, preferably hydrogen. The degree of permanent quaternization of Formula (I) may be from 0% to 22% of the polyethyleneimine backbone nitrogen atoms and is preferably 0%. The molecular weight of this amphiphilic alkoxylated polyethyleneimine polymer preferably is between 25,000 and 30,000, most preferably 28,000 Da.

The amphiphilic alkoxylated polyethyleneimine polymers can be made by the methods described in more detail in PCT Publication No. WO 2007/135645.

Alternatively, the compositions can be free of amphiphilic polymers.

### Cyclic Polyamine

The composition can comprise a cyclic polyamine having amine functionalities that helps cleaning. The composition of the invention preferably comprises from 0.1% to 3%, more preferably from 0.2% to 2%, and especially from 0.5% to 1%, by weight of the total composition, of the cyclic polyamine.

The cyclic polyamine has at least two primary amine functionalities. The primary amines can be in any position in the cyclic amine but it has been found that in terms of grease cleaning, better performance is obtained when the primary amines are in positions 1,3. It has also been found that cyclic amines in which one of the substituents is —CH3 and the rest are H provided for improved grease cleaning performance.

Accordingly, the most preferred cyclic polyamine for use with the cleaning composition of the present invention are cyclic polyamine selected from the group consisting of: 2-methylcyclohexane-1,3-diamine, 4-methylcyclohexane-1,3-diamine and mixtures thereof. These specific cyclic polyamines work to improve suds and grease cleaning profile through-out the dishwashing process when formulated together with the surfactant system of the composition of the present invention.

Suitable cyclic polyamines can be supplied by BASF, under the Baxxodur tradename, with Baxxodur ECX-210 being particularly preferred.

A combination of the cyclic polyamine and magnesium sulphate is particularly preferred. As such, the composition can further comprise magnesium sulphate at a level of from 0.001% to 2.0%, preferably from 0.005% to 1.0%, more preferably from 0.01% to 0.5% by weight of the composition.

### Triblock Copolymer

The composition of the invention can comprise a triblock copolymer. The triblock co-polymers can be present at a level of from 1% to 20%, preferably from 3% to 15%, more preferably from 5% to 12%, by weight of the total composition. Suitable triblock copolymers include alkylene oxide triblock co-polymers, defined as a triblock co-polymer having alkylene oxide moieties according to Formula (I): (EO)x(PO)y(EO)x, wherein EO represents ethylene oxide, and each x represents the number of EO units within the EO block. Each x can independently be on average of from 5 to 50, preferably from 10 to 40, more preferably from 10 to 30. Preferably x is the same for both EO blocks, wherein the “same” means that the x between the two EO blocks varies within a maximum 2 units, preferably within a maximum of 1 unit, more preferably both x's are the same number of units. PO represents propylene oxide, and y represents the number of PO units in the PO block. Each y can on average be from between 28 to 60, preferably from 30 to 55, more preferably from 30 to 48.

Preferably the triblock co-polymer has a ratio of y to each x of from 3:1 to 2:1. The triblock co-polymer preferably has a ratio of y to the average x of 2 EO blocks of from 3:1 to 2:1. Preferably the triblock co-polymer has an average weight percentage of total E-O of between 30% and 50% by weight of the tri-block co-polymer. Preferably the triblock co-polymer has an average weight percentage of total PO of between 50% and 70% by weight of the triblock co-polymer. It is understood that the average total weight % of EO and PO for the triblock co-polymer adds up to 100%. The triblock co-polymer can have an average molecular weight of between 2060 and 7880, preferably between 2620 and 6710, more preferably between 2620 and 5430, most preferably between 2800 and 4700. Average molecular weight is determined using a 1H NMR spectroscopy (see Thermo scientific application note No. AN52907).

Triblock co-polymers have the basic structure ABA, wherein A and B are different homopolymeric and/or monomeric units. In this case A is ethylene oxide (EO) and B is propylene oxide (PO). Those skilled in the art will recognize the phrase “block copolymers” is synonymous with this definition of “block polymers”.

Triblock co-polymers according to Formula (I) with the specific EO/PO/EO arrangement and respective homopolymeric lengths have been found to enhances suds mileage performance of the liquid hand dishwashing detergent composition in the presence of greasy soils and/or suds consistency throughout dilution in the wash process.

Suitable EO-PO-EO triblock co-polymers are commercially available from BASF such as Pluronic® PE series, and from the Dow Chemical Company such as Tergitol™ L series. Particularly preferred triblock co-polymer from BASF are sold under the tradenames Pluronic® PE6400 (MW ca 2900, ca 40 wt % EO) and Pluronic® PE 9400 (MW ca 4600, 40 wt % EO). Particularly preferred triblock co-polymer from the Dow Chemical Company is sold under the tradename Tergitol™ L64 (MW ca 2700, ca 40 wt % EO).

Preferred triblock co-polymers are readily biodegradable under aerobic conditions.

The composition of the present invention may further comprise at least one active selected from the group consisting of: i) a salt, ii) a hydrotrope, iii) an organic solvent, and mixtures thereof.

### Salt:

The composition of the present invention may comprise from about 0.05% to about 2%, preferably from about 0.1% to about 1.5%, or more preferably from about 0.5% to about 1%, by weight of the total composition of a salt, preferably a monovalent or divalent inorganic salt, or a mixture thereof, more preferably selected from: sodium chloride, sodium sulphate, and mixtures thereof. Sodium chloride is most preferred.

### Hydrotrope:

The composition of the present invention may comprise from about 0.1% to about 10%, or preferably from about 0.5% to about 10%, or more preferably from about 1% to about 10% by weight of the total composition of a hydrotrope or a mixture thereof, preferably sodium cumene sulphonate.

### Organic Solvent:

The composition can comprise from about 0.1% to about 10%, or preferably from about 0.5% to about 10%, or more preferably from about 1% to about 10% by weight of the total composition of an organic solvent. Suitable organic solvents include organic solvents selected from the group consisting of: alcohols, glycols, glycol ethers, and mixtures thereof, preferably alcohols, glycols, and mixtures thereof. Ethanol is the preferred alcohol. Polyalkyleneglycols, especially polypropyleneglycol, is the preferred glycol, with polypropyleneglycols having a weight average molecular weight of from 750 Da to 1,400 Da being particularly preferred.

### Adjunct Ingredients

The cleaning composition may optionally comprise a number of other adjunct ingredients such as builders (preferably citrate), chelants, conditioning polymers, other cleaning polymers, surface modifying polymers, structurants, emollients, humectants, skin rejuvenating actives, enzymes, carboxylic acids, scrubbing particles, perfumes, malodor control agents, pigments, dyes, opacifiers, pearlescent particles, inorganic cations such as alkaline earth metals such as Ca/Mg-ions, antibacterial agents, preservatives, viscosity adjusters (e.g., salt such as NaCl, and other mono-, di- and trivalent salts) and pH adjusters and buffering means (e.g. carboxylic acids such as citric acid, HCl, NaOH, KOH, alkanolamines, carbonates such as sodium carbonates, bicarbonates, sesquicarbonates, and alike).

### Packaged Product

The hand dishwashing detergent composition can be packaged in a container, typically plastic containers. Suitable containers comprise an orifice. Typically, the container comprises a cap, with the orifice typically comprised on the cap. The cap can comprise a spout, with the orifice at the exit of the spout. The spout can have a length of from 0.5 mm to 10 mm
The orifice can have an open cross-sectional surface area at the exit of from 3 mm² to 20 mm², preferably from 3.8 mm² to 12 mm², more preferably from 5 mm² to 10 mm², wherein the container further comprises the composition according to the invention. The cross-sectional surface area is measured perpendicular to the liquid exit from the container (that is, perpendicular to the liquid flow during dispensing).
The container can typically comprise from 200 ml to 5,000 ml, preferably from 350 ml to 2000 ml, more preferably from 400 ml to 1,000 ml of the liquid hand dishwashing detergent composition.

### Method of Washing

The invention is further directed to a method of manually washing dishware with the composition of the present invention. The method comprises the steps of delivering a composition of the present invention to a volume of water to form a wash solution and immersing the dishware in the solution. The dishware is be cleaned with the composition in the presence of water.

Optionally, the dishware can be rinsed. By “rinsing”, it is meant herein contacting the dishware cleaned with the process according to the present invention with substantial quantities of appropriate solvent, typically water. By “substantial quantities”, it is meant usually about 1 to about 20 L, or under running water.

The composition herein can be applied in its diluted form. Soiled dishware is contacted with an effective amount, typically from about 0.5 mL to about 20 mL (per about 25 dishes being treated), preferably from about 3 mL to about 10 mL, of the cleaning composition, preferably in liquid form, of the present invention diluted in water. The actual amount of cleaning composition used will be based on the judgment of the user and will typically depend upon factors such as the particular product formulation of the cleaning composition, including the concentration of active ingredients in the cleaning composition, the number of soiled dishes to be cleaned, the degree of soiling on the dishes, and the like. Generally, from about 0.01 mL to about 150 mL, preferably from about 3 mL to about 40 mL of a cleaning composition of the invention is combined with from about 2,000 mL to about 20,000 mL, more typically from about 5,000 mL to about 15,000 mL of water in a sink. The soiled dishware are immersed in the sink containing the diluted cleaning compositions then obtained, before contacting the soiled surface of the dishware with a cloth, sponge, or similar cleaning implement. The cloth, sponge, or similar cleaning implement may be immersed in the cleaning composition and water mixture prior to being contacted with the dishware, and is typically contacted with the dishware for a period of time ranged from about 1 to about 10 seconds, although the actual time will vary with each application and user. The contacting of cloth, sponge, or similar cleaning implement to the dishware is accompanied by a concurrent scrubbing of the dishware.

Alternatively, the composition herein can be applied in its neat form to the dish to be treated. By “in its neat form”, it is meant herein that said composition is applied directly onto the surface to be treated, or onto a cleaning device or implement such as a brush, a sponge, a nonwoven material, or a woven material, without undergoing any significant dilution by the user (immediately) prior to application. “In its neat form”, also includes slight dilutions, for instance, arising from the presence of water on the cleaning device, or the addition of water by the consumer to remove the remaining quantities of the composition from a bottle. Therefore, the composition in its neat form includes mixtures having the composition and water at ratios ranging from 50:50 to 100:0, preferably 70:30 to 100:0, more preferably 80:20 to 100:0, even more preferably 90:10 to 100:0 depending on the user habits and the cleaning task.

Another aspect of the present invention is directed to use of a hand dishwashing cleaning composition of the present invention for providing good sudsing profile, including suds stabilization in the presence of greasy soils, while not aggravating skin dryness during the ware washing process. Another aspect of the present invention is directed to use of a hydroxypropyl cellulose of the present invention for providing good finished product rheology control and ease of processability during a manufacturing process.

### Methods

A) Viscosity Measurement

The viscosity is measured using a controlled stress rheometer (such as an HAAKE MARS from Thermo Scientific, or equivalent), using a 60 mm 1° cone and a gap size of 52 microns at 20° C. After temperature equilibration for 2 minutes, the sample is sheared at a shear rate of 10 s-1 for 30 seconds. The reported viscosity of the liquid hand dishwashing detergent compositions is defined as the average shear stress between 15 seconds and 30 seconds shearing divided by the applied shear rate of 10 s-1 at 20° C.

B) Molecular Weight Determination by Gel Permeation Chromatography:

Gel Permeation Chromatography (GPC) with Multi-Angle Light Scattering (MALS) and Refractive Index (RI) Detection (GPC-MALS/RI) is a well known system to directly measure the weight average molecular weight, M_{w}, and number average molecular weight, Mₙ, of a polymer without the need for comparisons with known reference standards.

The true number-average molecular weight, Mₙ, of polymers can be obtained by GPC coupled with light-scattering detection and refractive index detection even if the composition and therefore the refractive index increment varies with elution volume, provided slices taken are sufficiently monodisperse with respect to molecular weight and composition.

For example, the molecular weight distribution of hydroxypropylcellulose polymer can be measured using a Liquid Chromatography system such as an Agilent 1260 Infinity pump system with OpenLab Chemstation software (from Agilent Technology, Santa Clara, Calif., USA) provided with two ultrahydrogel linear columns, 7.8 mm ID×300 mm length used in series (S/N 002C180181 VE077 and 005C180181 VE084, supplied by Waters Corporation of Milford, Mass., USA) and an ultrahydrogel guard column (6 mm ID×40 mm length, S/N2016260401BE105, also supplied Waters Corporation of Milford, Mass., USA) installed between the injector and the analytical column to prevent any impurities and suspended solids from reaching the analytical column, operated at 40° C. A multiangle light scattering (MALS) detector DAWN® and a differential refractive index (RI) detector (Wyatt Technology of Santa Barbara, Calif., USA) controlled by Wyatt Astra® software can be used for the detection.

Since the analytes are spread over a relatively narrow time window, an isocratic rather than gradient elution method can be used. Isocratic means that the mixture of your mobile phase is consistent over the complete testing time. Using a gradient implies that the compounding of the eluent mixture is changed during measurement and so influences the retention of analytes. The separation can be either accelerated or decelerated when using a gradient method.

0.1M sodium nitrate in water containing 0.02% sodium azide is used as the mobile phase. Samples are prepared by dissolving the hydroxypropylcellulose polymer in the mobile phase at ˜1.0 mg per ml and by mixing the solution overnight at room temperature to ensure full hydration of the polymer. The sample is then filtered through a 0.8 μm Versapor membrane filter (AP4189, supplied by PALL, Life Sciences, NY, USA) into the LC autosampler vial using a 3-ml syringe. The sample is then pumped into the columns at a flow rate of 1.0 mL/min

The number average and weight average molecular weights of the hydroxypropylcellulose polymer are calculated from the dn/dc (differential change of refractive index with concentration) measurements, as provided by the Astra detector software.

C) Suds Mileage

The objective of the Suds Mileage Test is to compare the evolution over time of suds volume generated for different test formulations at specified water hardness, solution temperatures and formulation concentrations, while under the influence of periodic soil injections. Data are compared and expressed versus a reference composition as a suds mileage index (reference composition has suds mileage index of 100). The steps of the method are as follows:
1. 0.12 wt % of the test composition is dispensed through a plastic pipette at a flow rate of 0.67 mL/sec at a height of 37 cm above the bottom surface of a sink (dimension: 300 mm diameter and 288 mm height) into a water stream having a water hardness of 2.67 mmol/L equivalence of Ca (15 gpg) and water temperature of 35° C., that is filling up the sink to 4 L at a constant pressure of 4 bar.
2. An initial suds volume generated (measured as average foam volume X above the liquid in the sink (expressed in cm³) is recorded immediately after end of filling.
3. A fixed amount (6 mL) of a soil with the defined composition below is immediately injected into the middle of the sink.
4. The resultant solution is mixed with a metal blade (10 cm×5 cm) positioned in the middle of the sink at the air liquid interface under an angle of 45° rotating at 85 RPM for 20 revolutions.
5. Another measurement of the total suds volume is recorded immediately after end of blade rotation.
6. Steps 3-5 are repeated until the measured total suds volume reaches a level of 400 cm³ or less. The amount of added soil that is needed to get to the 400 cm³ level is considered as the suds mileage for the test composition.
7. Each test composition is tested 4 times per testing condition (i.e., water temperature, composition concentration, water hardness, soil type).
8. The average suds mileage is calculated as the average of the 4 replicates for each sample for a defined test condition.
9. The Suds Mileage Index is calculated by comparing the average mileage of a test composition sample versus a reference composition sample. The calculation is as follows:

$$Suds Mileage Index = \frac{\begin{matrix}Average number of soil additions \\ of test composition\end{matrix}}{\begin{matrix}Average number of soil additions \\ of reference composition\end{matrix}} \times 100$$

The greasy soil composition used in the test is produced through standard mixing of the components described in Table 1.

TABLE 1
Greasy Soil

| Ingredient | Weight % |
|---|---|
| Crisco Oil | 12.730 |
| Crisco shortening | 27.752 |
| Lard | 7.638 |
| Refined Rendered Edible | 51.684 |
| Beef Tallow | |
| Oleic Acid, 90% (Techn) | 0.139 |
| Palmitic Acid, 99+% | 0.036 |
| Stearic Acid, 99+% | 0.021 |

D) Liposome Disruption

Liposome disruption measured via fluorescence was used to assess the skin mildness of liquid detergent compositions. Dispersions of 200 nm unilamellar liposomes consisting of 1,2-dipalmitoyl-sn-glycero-3-phosphocholine (DPPC) with encapsulated calcein fluorescent dye were used (supplied by ACM Biolabs, Singapore). A diluted liposome dispersion was prepared by diluting 64 μL of the DPPC liposome dispersion (5 mM DPPC) with 24 mL of 0.01 M phosphate buffered saline solution. This buffer was prepared by dissolving 1 tablet of phosphate buffered saline (supplied by P4417 from Sigma Aldrich) in 200 ml demi water to obtain a 137 mM NaCl, 2.7 mM KCl and 10 mM phosphate buffer solution (pH 7.4 at 25° C.). A 0.1 wt % Triton X-100 aqueous solution, a strongly liposome disrupting active, was used as a control. Detergent solutions were prepared by diluting the liquid detergent in demineralized water to a level of 0.5 wt % of the liquid detergent.

Wells of a 96-microtiter plate were filled with 225 μL of the diluted liposome dispersion. In one well nothing was further added to the diluted liposome dispersion (nil-reference) and 25 μL of the 0.1% Triton X-100 solution was added to the diluted liposome dispersion in another well (Triton X-reference). In the other wells 25 μL of 0.5 wt % detergent solutions was added to the diluted liposome dispersion. 4 replicates were prepared for each measurement point.

Fluorescence was measured using a FLUOstar Optima plate reader (commercially available from BMG LABTECH), with excitation and emission filters set at 490 and 520 nm, respectively.

As the liposome bilayer is disrupted, more of the calcein fluorescent dye is released in solution. Hence, the degree of liposome bilayer disruption can be measured by the increase in fluorescence.

The degree of liposome bilayer disruption from the detergent samples, relative to that from Triton X, can be represented as a Liposome Disruption Index (LDI—the higher, the worse) which is calculated as:

$$LDI ( \% ) = \frac{\begin{matrix}[ flourescence from sample - \\ flourescence from nil - reference ] \times 100\end{matrix}}{\begin{matrix}[ flourescence from triton \times reference - \\ flourescence from nil - reference ]\end{matrix}}$$

The Liposome Disruption Index (LDI %) was measured after 5, 15, 30, and 60 minutes exposure time at room temperature and static conditions and the results averaged over the four replicates.

### EXAMPLES

The following hydroxypropylcellulose (HPC) and hydroxypropylmethylcellulose (HPMC) materials were evaluated for suds mileage, liposome disruption, and viscosity stability:

The hydroxypropylmethylcellulose (Methocel E50) is a comparative HPMC polymer having essentially the same molecular weight and polydispersity as the hydroxypropylcellulose (Klucel E) of use in the present invention,

TABLE 2
Molecular weight of HPC and HPMC test samples

| Cellulose ether | Mn [kDa] | Mw [kDa] | Tradename |
|---|---|---|---|
| Hydroxypropylcellulose¹ | 40 | 82 | Klucel E |
| Hydroxypropylmethylcellulose²* | 38 | 93 | Methocel E50 |

*not of use in the present invention
¹supplied by Ashland, degree of molar hydroxypropyl substitution 3.7
²supplied by Dow

Suds Mileage and Viscosity

Table 3 shows the suds mileage index in the presence of greasy soils and viscosity for a liquid hand dishwashing composition comprising no cellulose polymer, liquid hand dishwashing detergent compositions of the present invention comprising hydroxypropylcellulose, and comparative liquid hand dishwashing detergent compositions comprising hydroxypropylmethylcellulose.

The liquid hand dishwashing detergent compositions were prepared by mixing together of the individual raw materials at room temperature using a batch type process.

TABLE 3
Liquid hand dishwashing detergent compositions

| Wt % (as 100% active) | Ex 1* | Ex 2a | Ex 2b | Ex 3a* | Ex 3b* |
|---|---|---|---|---|---|
| C12-13AE0.6S | 19.6 | 19.6 | 19.6 | 19.6 | 19.6 |
| C12-14 dimethyl amine oxide | 6.53 | 6.53 | 6.53 | 6.53 | 6.53 |
| NaCl | 0.7 | 0.7 | 0.7 | 0.7 | 0.7 |
| Polypropylene glycol (MW 2000) | 0.7 | 0.7 | 0.7 | 0.7 | 0.7 |
| Ethanol | 1.8 | 1.8 | 1.8 | 1.8 | 1.8 |
| Neodol 91-8 | 1 | 1 | 1 | 1 | 1 |
| Hydroxypropylcellulose (Mn 40k)¹ | — | 0.3 | 0.5 | — | — |
| Hydroxypropylmethylcellulose (Mn 38k)²* | — | — | — | 0.3 | 0.5 |
| Water + minors (perfume, | To | To | To | To | To |
| dye, preservatives) | 100% | 100% | 100% | 100% | 100% |
| pH (as 10% solution in demi | 9 | 9 | 9 | 9 | 9 |
| water, trimmed with NaOH) | | | | | |
| Viscosity [cP] | 741 | 826 | 876 | 1085 | 1398 |
| Suds mileage in the presences of | 100 | 111 | 114 | 106 | 106 |
| greasy soil (35° C., 15 dH) | | | | | |

*comparative

As can be seen from the suds mileage results, the compositions comprising hydroxypropylcellulose result in a superior suds mileage in the presence of greasy soils, both in comparison to compositions that do not comprise a cellulose polymer, and comparative compositions comprising hydroxypropylmethylcellulose instead.

In addition, the compositions comprising hydroxypropylcellulose result in improved control of viscosity in comparison to the comparative compositions comprising hydroxypropylmethylcellulose.

Liposome Disruption (Skin Mildness)

Table 4 shows the liposome disruption behaviour for a liquid hand dishwashing composition comprising no cellulose polymer, liquid hand dishwashing detergent compositions of the present invention comprising hydroxypropylcellulose, and comparative liquid hand dishwashing detergent compositions comprising hydroxypropylmethylcellulose.

The liquid hand dishwashing detergent compositions were prepared by mixing together of the individual raw materials at room temperature using a batch type process.

TABLE 4
Liposome disruption data

| Wt % (as 100% active) | | Ex 4* | Ex 5 | Ex 6* |
|---|---|---|---|---|
| C12-13AE0.6S | | 19.6 | 19.6 | 19.6 |
| C12-14 dimethyl amine oxide | | 6.53 | 6.53 | 6.53 |
| NaCl | | 0.7 | 0.7 | 0.7 |
| Polypropylene glycol (MW 2000) | | 0.7 | 0.7 | 0.7 |
| Ethanol | | 1.8 | 1.8 | 1.8 |
| Neodol 91-8 | | 1 | 1 | 1 |
| Hydroxypropylcellulose | | — | 0.15 | — |
| (Mn 40k)¹ | | | | |
| Hydroxypropylmethylcellulose | | — | — | 0.15 |
| (Mn 38k)²* | | | | |
| Water + minors (perfume, | | To | To | To |
| dye, preservatives) | | 100% | 100% | 100% |
| pH (as 10% solution in demi | | 9 | 9 | 9 |
| water, trimmed with NaOH) | | | | |
| Liposome | 5 min | 8.5 | 7.8 | 19.3 |
| disruption | 15 min | 14.3 | 14.0 | 31.0 |
| [%] | 30 min | 22.0 | 24.5 | 59.5 |
| | 60 min | 46.5 | 46.5 | 70.3 |

*comparative

As can be seen from the liposome disruption results, the compositions comprising hydroxypropylcellulose result in superior skin mildness in comparison to equivalent compositions which comprise hydroxypropylmethylcellulose. Indeed, the skin mildness is very close to the reference composition which did not comprise a cellulose polymer.

Polymer Solution Viscosity:

Polymer solutions from 2.0% to 6.0% in demineralised water were prepared from the powder samples of the hydroxypropylcellulose and hydroxypropylmethylcellulose, by dissolving the powder in demineralized water at room temperature by normal stirring with a magnetic stirrer.

The resultant viscosities are given in Table 5:

TABLE 5
Viscosity of aqueous polymer solutions

| | Hydroxypropylcellulose | Hydroxypropylmethylcellulose |
|---|---|---|
| Mn (kDa) | 40 | 38 |
| Mw (kDa) | 82 | 93 |

| Concentration | Viscosity (mPas) | Viscosity (mPas) |
|---|---|---|
| 2% | 7 | 52 |
| 4% | 28 | 406 |
| 6% | 90 | 1894 |

As can be seen from the viscosity data above, the aqueous solutions of hydroxypropylcellulose have a significantly lower viscosity than equivalent aqueous solutions of hydroxypropylmethyulcellulose, even though they have similar molecular weights. As such, higher concentration premixes can be made which results in easier processibility into the resultant liquid hand dishwashing composition.

Hence, while hydroxypropylmethylcellulose polymers have been previously identified as providing improved suds mileage in the presence of greasy soils, hydroxypropylcellulose polymers have been found to provide further improvements in suds mileage while being easier to process, having less influence on the detergent composition viscosity and providing improved skin mildness.

The following hydroxypropylcellulose (HPC) and hydroxyethylcellulose (HEC) materials were evaluated for suds mileage in the presence of greasy soil:

Natrasol® Plus CS 330 is a comparative hydroxyethylcellulose (HEC) polymer having essentially the same molecular weight and polydispersity as the hydroxypropylcellulose (Klucel® G).

TABLE 6
Molecular weight of HPC and HPMC test samples

| Cellulose ether | Mw [kDa] | Tradename |
|---|---|---|
| Hydroxypropylcellulose³* | 370 | Klucel ® G |
| Hydroxyethylcellulose⁴* | 350 | Natrasol ® Plus CS 330 |

*not of use in the present invention
³supplied by Ashland, degree of molar hydroxypropyl substitution 3.2
⁴supplied by Ashland, degree of molar hydroxyethyl substitution of 3.1

Suds Mileage

Table 7 shows the suds mileage index in the presence of greasy soils for a liquid hand dishwashing composition comprising no cellulose polymer, liquid hand dishwashing detergent compositions of the present invention comprising hydroxypropylcellulose, and comparative liquid hand dishwashing detergent compositions comprising hydroxyethylcellulose.

The liquid hand dishwashing detergent compositions were prepared by mixing together of the individual raw materials at room temperature using a batch type process.

TABLE 3
Liquid hand dishwashing detergent compositions

| Wt % (as 100% active) | Ex 1* | Ex 4* | Ex 5* |
|---|---|---|---|
| C12-13AE0.6S | 19.6 | 19.6 | 19.6 |
| C12-14 dimethyl amine oxide | 6.53 | 6.53 | 6.53 |
| NaCl | 0.7 | 0.7 | 0.7 |
| Polypropylene glycol (MW 2000) | 0.7 | 0.7 | 0.7 |
| Ethanol | 1.8 | 1.8 | 1.8 |
| Neodol 91-8 | 1 | 1.0 | 1.0 |
| Hydroxypropylcellulose | — | 0.3 | — |
| (Mw 370k)³* | | | |
| Hydroxyethylcellulose | — | — | 0.3 |
| (Mw 350k)⁴* | | | |
| Water + minors (perfume, | To | To | To |
| dye, preservatives) | 100% | 100% | 100% |
| pH (as 10% solution in demi | 9 | 9 | 9 |
| water, trimmed with NaOH) | | | |
| Suds mileage in the presences of | 100 | 113 | 104 |
| greasy soil (35° C., 15 dH) | | | |

*comparative

The hydroxypropylcellulose (Klucel® G) has a number average molecular weight of above 250 kDa, it is not of use in the present invention. However, as can be seen from the suds mileage results, compositions comprising hydroxypropylcellulose result in a superior suds mileage in the presence of greasy soils, in comparison to compositions that comprise a hydroxyethylcellulose polymer of similar molecular weight.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

1. A liquid hand dishwashing detergent composition comprising:
from 5.0% to 50% of a surfactant system by weight of the liquid hand dishwashing detergent composition, wherein the surfactant system comprises:
a. an anionic surfactant selected from the group consisting of: alkyl sulphate surfactant, alkyl sulphonate surfactant, alkyl sulphosuccinate and dialkyl sulphosuccinate ester surfactants, and mixtures thereof; and
b. a co-surfactant selected from the group consisting of: amphoteric co-surfactant, zwitterionic co-surfactant, and mixtures thereof; and
from 0.01% to 3.0% of a hydroxypropylcellulose polymer by weight of the liquid hand dishwashing detergent composition, wherein the hydroxypropylcellulose polymer has a number average molecular weight of from 5 kDa to 250 kDa.

2. The liquid hand dishwashing detergent composition according to claim 1, wherein the liquid hand dishwashing detergent composition comprises from 6.0% to 40% of the surfactant system by weight of the liquid hand dishwashing detergent composition.

3. The liquid hand dishwashing detergent composition according to claim 1, wherein the surfactant system comprises at least 50% of an anionic surfactant by weight of the surfactant system.

4. The liquid hand dishwashing detergent composition according to claim 1, wherein the anionic surfactant comprises at least 70% of alkyl sulphate anionic surfactant by weight of the anionic surfactant.

5. The liquid hand dishwashing detergent composition according to claim 4, wherein the alkyl sulphate anionic surfactant has a number average alkyl chain length of from 8 to 18 carbon atoms.

6. The liquid hand dishwashing detergent composition according to claim 4, wherein the alkyl sulphate anionic surfactant is an alkyl alkoxy sulphate anionic surfactant having an average degree of alkoxylation of less than 3.5.

7. The liquid hand dishwashing detergent composition according claim 4, wherein the alkyl sulphate anionic surfactant has a weight average degree of branching of at least 10%.

8. The liquid hand dishwashing detergent composition according to claim 1, wherein the anionic surfactant and the co-surfactant are present in a weight ratio of from 1:1 to 8:1.

9. The liquid hand dishwashing detergent composition according to claim 1, wherein the co-surfactant is an amphoteric surfactant comprising alkyl dimethyl amine oxide, alkyl amido propyl dimethyl amine oxide, or mixtures thereof.

10. The liquid hand dishwashing detergent composition according to claim 1, wherein the co-surfactant is a zwitterionic surfactant comprising alkyl betaines, alkylamidoalkylbetaine, amidazoliniumbetaine, sulphobetaine (INCI Sultaines), phosphobetaine, or mixtures thereof.

11. The liquid hand dishwashing detergent composition according to claim 1, wherein the liquid hand dishwashing detergent composition comprises from 0.05% to 2.0% of the hydroxypropylcellulose polymer by weight of the liquid hand dishwashing detergent composition.

12. The liquid hand dishwashing detergent composition according to claim 1, wherein the hydroxypropylcellulose polymer has a number average molecular weight of from 10 kDa to 100 kDa.

13. The liquid hand dishwashing detergent composition according to claim 1, wherein the hydroxypropylcellulose polymer has the structure: 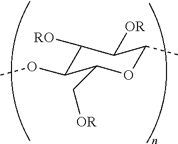
wherein:
each R is independently H or CH₂CH(OR′)CH₃;
R′ is H or R; and
n is from 15 to 650.

14. The liquid hand dishwashing detergent composition according to claim 1, wherein the hydroxypropylcellulose polymer has a degree of molar substitution (MS) of hydroxypropyl of from 0.5 to 5.0.

15. The liquid hand dishwashing detergent composition according to claim 1, wherein the surfactant system further comprises a nonionic surfactant.

16. The liquid hand dishwashing detergent composition according to claim 15, wherein the nonionic surfactant comprises alkoxylated alcohol nonionic surfactants, alkyl polyglucoside nonionic surfactants, or mixtures thereof.

17. The liquid hand dishwashing detergent composition according to claim 14, wherein:
each R is independently H or CH₂CH(OR′)CH₃;
R′ is H or R; and
n is from 80 to 130.

18. The liquid hand dishwashing detergent composition according to claim 1, wherein the hydroxypropylcellulose polymer has a degree of molar substitution (MS) of hydroxypropyl of from 1.0 to 4.5.

19. The liquid hand dishwashing detergent composition according to claim 1, wherein the liquid hand dishwashing detergent composition comprises from 15% to 35% of the surfactant system by weight of the liquid hand dishwashing detergent composition.

20. The liquid hand dishwashing detergent composition according to claim 1, wherein:
the liquid hand dishwashing detergent composition comprises from 15% to 35% of the surfactant system by weight of the liquid hand dishwashing detergent composition;
the surfactant system comprises from 65% to 85% of an alkyl sulphate anionic surfactant by weight of the surfactant system, the alkyl suphate anionic surfactant having a number average alkyl chain length of from 10 to 14 carbon atoms and an average degree of alkoxylation of from 0.5 to 0.9;
the anionic surfactant and the co-surfactant are present in a weight ratio of from 2:1 to 5:1; and
the liquid hand dishwashing detergent composition comprises from 0.1% to 1.0% of the hydroxypropylcellulose polymer by weight of the liquid hand dishwashing detergent composition, the hydroxypropylcellulose polymer having a degree of molar substitution (MS) of hydroxypropyl of from 2.0 to 4.0.
